(19) United States
(12) Patent Application Publication
(10) Pub. No.: US 2023/0292207 A1
(43) Pub. Date: Sep. 14, 2023

(54) FAST TRANSITIONS BETWEEN RADIO ACCESS TECHNOLOGIES (RATS) BASED ON ENERGY THRESHOLDS

(71) Applicant: QUALCOMM Incorporated, San Diego, CA (US)

(72) Inventors: Tanay KABRA, Hyderabad (IN); Akash SRIVASTAVA, Hyderabad (IN); Rajesh NADAVA, Hyderabad (IN)

(21) Appl. No.: 18/005,886

(22) PCT Filed: May 11, 2021
(86) PCT No.: PCT/US2021/031821

§ 371 Date: Jan. 18, 2023

(30) Foreign Application Priority Data
Sep. 11, 2020 (IN) 202041039407

(51) Int. Cl. H04W 36/30; H04W 36/06

(52) U.S. Cl. CPC H04W 36/30; H04W 36/06

(57) ABSTRACT

Aspects of the present disclosure relate to wireless communications, and more particularly, to techniques for rapidly camping on frequencies for a second (e.g., non-legacy) radio access technology (RAT) after discontinuing communications using a first (e.g., legacy) RAT. An example method generally includes terminating an active communications session on a first radio access technology (RAT), measuring signal strength of one or more frequencies supporting a second RAT in a configured list of frequencies, identifying a frequency to camp on based on a priority and a measured signal strength of each frequency in the configured list of frequencies, and camping on the identified frequency.

### CROSS-REFERENCE TO RELATED APPLICATIONS

This application claims benefit to India Provisional Patent Application Serial No. 202041039407, filed Sep. 11, 2020, entitled “Fast Transitions Between Radio Access Technologies (RATs) Based on Energy Thresholds” and assigned to the assignee hereof, the contents of which are hereby incorporated by reference in its entirety.

### TECHNICAL FIELD

Aspects of the present disclosure relate to wireless communications, and more particularly, to fast transitions between different radio access technologies (RATs) used for communications between a user equipment (UE) and a base station based on energy thresholds.

### BACKGROUND

Wireless communication systems are widely deployed to provide various telecommunication services such as telephony, video, data, messaging, broadcasts, etc. These wireless communication systems may employ multiple-access technologies capable of supporting communication with multiple users by sharing available system resources (for example, bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

These multiple access technologies have been adopted in various telecommunication standards to provide a common protocol that enables different wireless devices to communicate on a municipal, national, regional, and even global level. New radio (for example, 5G NR) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

However, as the demand for mobile broadband access continues to increase, there exists a need for further improvements in NR and LTE technology. Preferably, these improvements should be applicable to other multi-access technologies and the telecommunication standards that employ these technologies.

### SUMMARY

The systems, methods, and devices of the disclosure each have several innovative aspects, no single one of which is solely responsible for the desirable attributes.

One innovative aspect of the subject matter described in this disclosure can be implemented in a method for wireless communication by a user equipment (UE). The method generally includes terminating an active communications session on a first radio access technology (RAT); measuring signal strength of one or more frequencies on which a second RAT is supported in a configured list of frequencies; identifying a frequency to camp on based on a priority and a measured signal strength of each frequency in the configured list of frequencies; and camping on the identified frequency.

Aspects of the present disclosure provide means for, apparatus, processors, and computer-readable mediums for performing the methods described herein.

To the accomplishment of the foregoing and related ends, the one or more aspects comprise the features hereinafter fully described and particularly pointed out in the claims. The following description and the appended drawings set forth in detail some illustrative features of the one or more aspects. These features are indicative, however, of but a few of the various ways in which the principles of various aspects may be employed.

### BRIEF DESCRIPTION OF THE DRAWINGS

Details of one or more implementations of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims.

FIG. 1 shows an example wireless communication network in which some aspects of the present disclosure may be performed.

FIG. 2 shows a block diagram illustrating an example base station (BS) and an example user equipment (UE) in accordance with some aspects of the present disclosure.

FIG. 3A illustrates an example of a frame format for a telecommunication system.

FIG. 3B illustrates how different synchronization signal blocks (SSBs) may be sent using different beams.

FIG. 4 illustrates examples operations for wireless communication by a user equipment (UE), in accordance with some aspects of the present disclosure.

FIG. 5 illustrates an example timeline of transitions between a first radio access technology (RAT) and a second RAT, in accordance with some aspects of the present disclosure.

FIG. 6 illustrates an example prioritization of frequencies for communications using a second radio access technology (RAT) on which a UE is to camp on after discontinuing communications using a first RAT, in accordance with some aspects of the present disclosure.

FIG. 7 illustrates a communications device that may include various components configured to perform operations for the techniques disclosed herein in accordance with aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure relate to wireless communications, and more particularly, to techniques that allow for a user equipment (UE) to rapidly transition to communications using a second (e.g., non-legacy) radio access technology (RAT) after discontinuing communications using a first (e.g., legacy) RAT based on energy thresholds.

The following description provides examples of rapidly transitioning to communications using a second radio access technology (RAT) after discontinuing communications using a first RAT based on energy thresholds, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs. In some cases, a 5G NR RAT network may be deployed.

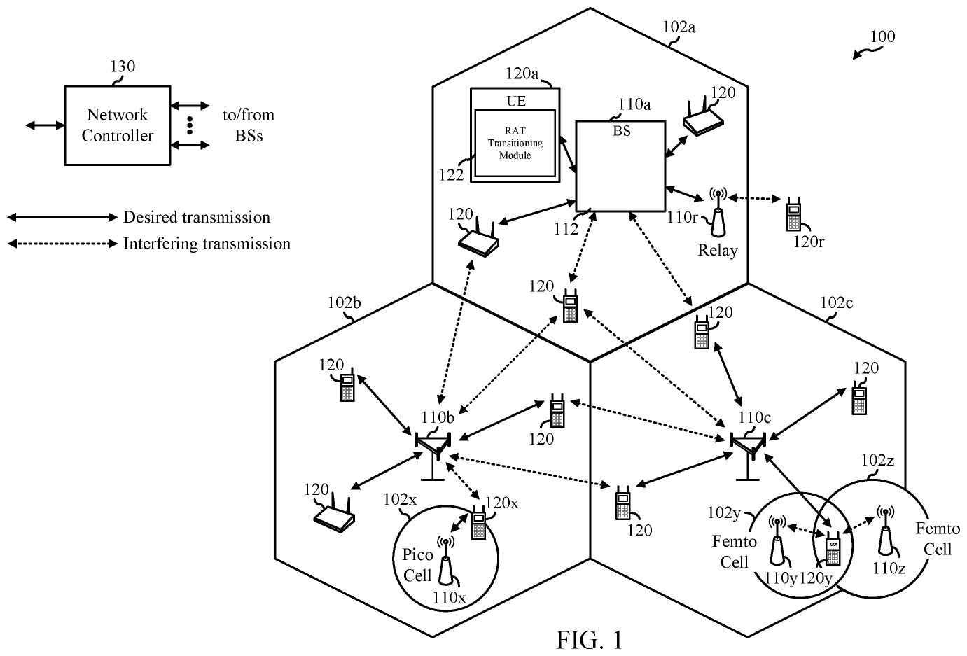

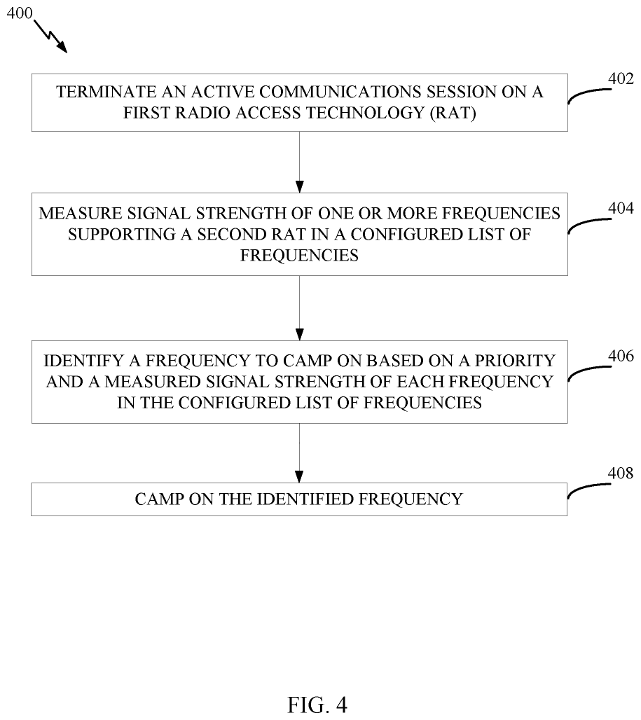

FIG. 1 illustrates an example wireless communication network 100 in which aspects of the present disclosure may be performed. For example, as shown in FIG. 1, UE 120a may include a reference signal configuration module 122 that may be configured to perform (or cause UE 120a to perform) operations 400 of FIG. 4.

NR access (for example, 5G NR) may support various wireless communication services, such as enhanced mobile broadband (eMBB) targeting wide bandwidth (for example, 80 MHz or beyond), millimeter wave (mmWave) targeting high carrier frequency (for example, 25 GHz or beyond), massive machine type communications MTC (mMTC) targeting non-backward compatible MTC techniques, or mission critical services targeting ultra-reliable low-latency communications (URLLC). These services may include latency and reliability requirements. These services may also have different transmission time intervals (TTI) to meet respective quality of service (QoS) requirements. In addition, these services may co-exist in the same time-domain resource (for example, a slot or subframe) or frequency-domain resource (for example, component carrier).

As illustrated in FIG. 1, the wireless communication network 100 may include a number of base stations (BSs) 110a-z (each also individually referred to herein as BS 110 or collectively as BSs 110) and other network entities. A BS 110 may provide communication coverage for a particular geographic area, sometimes referred to as a “cell”, which may be stationary or may move according to the location of a mobile BS 110. In some examples, the BSs 110 may be interconnected to one another or to one or more other BSs or network nodes (not shown) in wireless communication network 100 through various types of backhaul interfaces (for example, a direct physical connection, a wireless connection, a virtual network, or the like) using any suitable transport network. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. A BS may support one or multiple cells. The BSs 110 communicate with user equipment (UEs) 120a-y (each also individually referred to herein as UE 120 or collectively as UEs 120) in the wireless communication network 100. The UEs 120 (for example, 120x, 120y, etc.) may be dispersed throughout the wireless communication network 100, and each UE 120 may be stationary or mobile.

Wireless communication network 100 may also include relay stations (for example, relay station 110r), also referred to as relays or the like, that receive a transmission of data or other information from an upstream station (for example, a BS 110a or a UE 120r) and sends a transmission of the data or other information to a downstream station (for example, a UE 120 or a BS 110), or that relays transmissions between UEs 120, to facilitate communication between devices.

A network controller 130 may couple to a set of BSs 110 and provide coordination and control for these BSs 110. The network controller 130 may communicate with the BSs 110 via a backhaul. The BSs 110 may also communicate with one another (for example, directly or indirectly) via wireless or wireline backhaul.

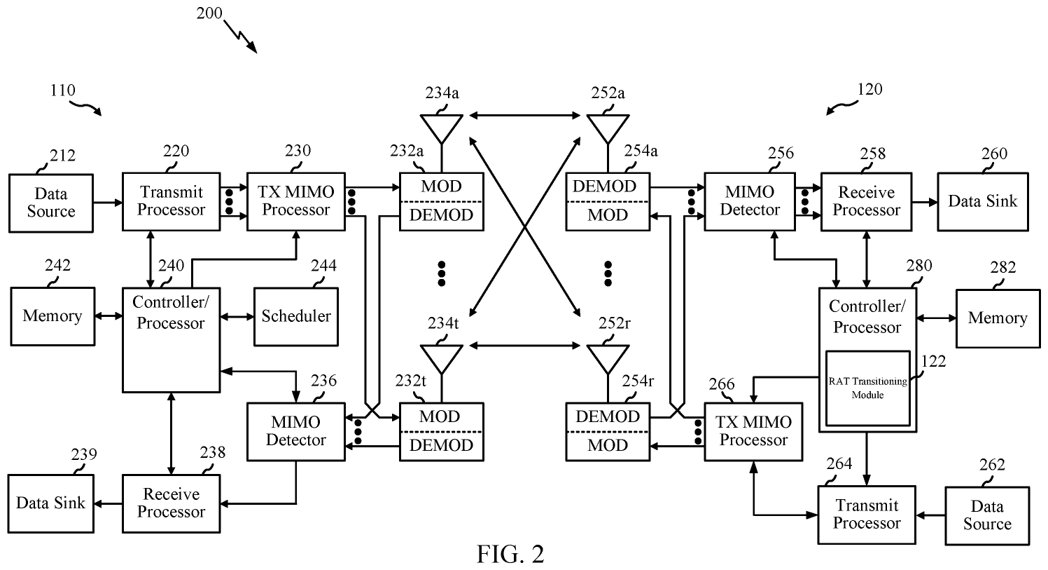

FIG. 2 shows a block diagram illustrating an example base station (BS) and an example user equipment (UE) in accordance with some aspects of the present disclosure.

At the BS 110, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. The processor 220 may process (for example, encode and symbol map) the data and control information to obtain data symbols and control symbols, respectively. The transmit processor 220 may also generate reference symbols, such as for the primary synchronization signal (PSS), secondary synchronization signal (SSS), and cell-specific reference signal (CRS). A transmit (TX) multiple-input multiple-output (MIMO) processor 230 may perform spatial processing (for example, precoding) on the data symbols, the control symbols, or the reference symbols, if applicable, and may provide output symbol streams to the modulators (MODs) 232a-232t. Each modulator 232 may process a respective output symbol stream (for example, for OFDM, etc.) to obtain an output sample stream. Each modulator may further process (for example, convert to analog, amplify, filter, and upconvert) the output sample stream to obtain a downlink signal. Downlink signals from modulators 232a-232t may be transmitted via the antennas 234a-234t, respectively.

At the UE 120, the antennas 252a-252r may receive the downlink signals from the BS 110 and may provide received signals to the demodulators (DEMODs) in transceivers 254a-254r, respectively. Each demodulator 254 may condition (for example, filter, amplify, downconvert, and digitize) a respective received signal to obtain input samples. Each demodulator may further process the input samples (for example, for OFDM, etc.) to obtain received symbols. A MIMO detector 256 may obtain received symbols from all the demodulators 254a-254r, perform MIMO detection on the received symbols if applicable, and provide detected symbols. A receive processor 258 may process (for example, demodulate, deinterleave, and decode) the detected symbols, provide decoded data for the UE 120 to a data sink 260, and provide decoded control information to a controller/processor 280.

On the uplink, at UE 120, a transmit processor 264 may receive and process data (for example, for the physical uplink shared channel (PUSCH)) from a data source 262 and control information (for example, for the physical uplink control channel (PUCCH) from the controller/processor 280. The transmit processor 264 may also generate reference symbols for a reference signal (for example, for the sounding reference signal (SRS)). The symbols from the transmit processor 264 may be precoded by a TX MIMO processor 266 if applicable, further processed by the demodulators in transceivers 254a-254r (for example, for SC-FDM, etc.), and transmitted to the BS 110. At the BS 110, the uplink signals from the UE 120 may be received by the antennas 234, processed by the modulators 232, detected by a MIMO detector 236 if applicable, and further processed by a receive processor 238 to obtain decoded data and control information sent by the UE 120. The receive processor 238 may provide the decoded data to a data sink 239 and the decoded control information to the controller/processor 240.

The memories 242 and 282 may store data and program codes for BS 110 and UE 120, respectively. A scheduler 244 may schedule UEs for data transmission on the downlink or uplink.

The controller/processor 280 or other processors and modules at the UE 120 may perform or direct the execution of processes for the techniques described herein. As shown in FIG. 2, the controller/processor 280 of the UE 120 has a RAT transitioning module 122 that may be configured to perform (or cause UE 120 to perform) operations 400 of FIG. 4.

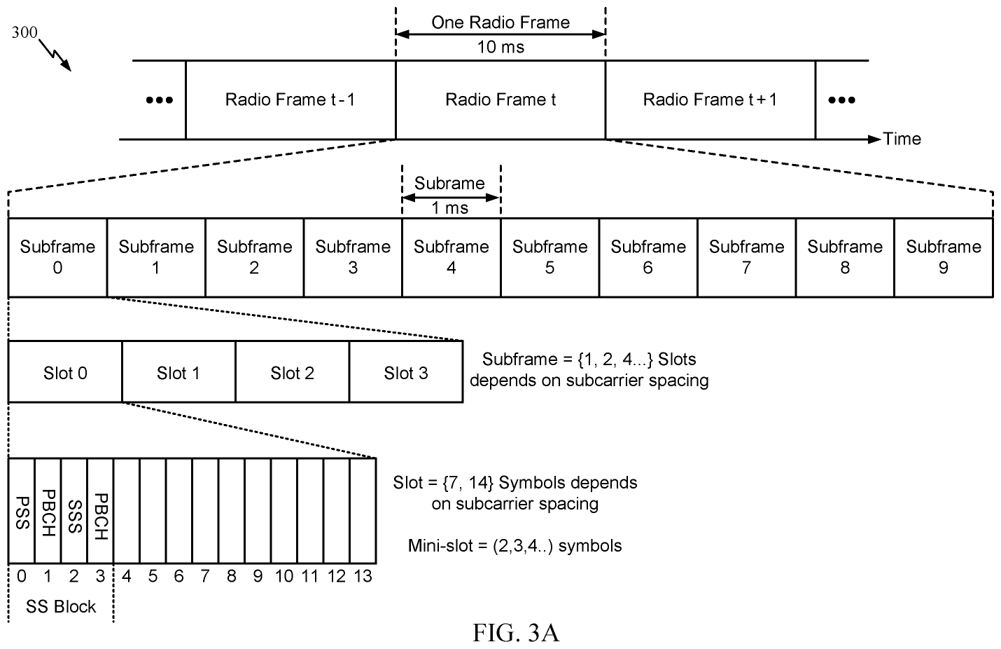

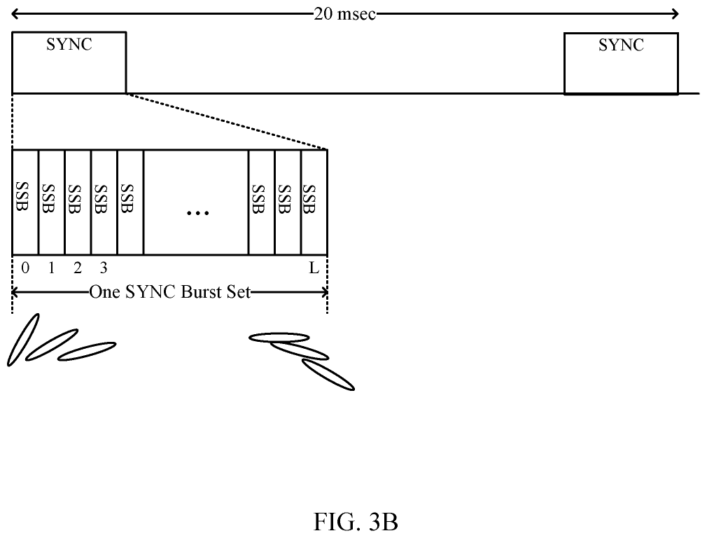

FIG. 3A is a diagram showing an example of a frame format 300 for NR. The transmission timeline for each of the downlink and uplink may be partitioned into units of radio frames. Each radio frame may have a predetermined duration (e.g., 10 ms) and may be partitioned into 10 subframes, each of 1 ms, with indices of 0 through 9. Each subframe may include a variable number of slots depending on the subcarrier spacing. Each slot may include a variable number of symbol periods (e.g., 7 or 14 symbols) depending on the subcarrier spacing. The symbol periods in each slot may be assigned indices. A mini-slot, which may be referred to as a sub-slot structure, refers to a transmit time interval having a duration less than a slot (e.g., 2, 3, or 4 symbols).

Each symbol in a slot may indicate a link direction (e.g., DL, UL, or flexible) for data transmission and the link direction for each subframe may be dynamically switched. The link directions may be based on the slot format. Each slot may include DL/UL data as well as DL/UL control information.

In NR, a synchronization signal (SS) block is transmitted. The SS block includes a PSS, a SSS, and a two symbol PBCH. The SS block can be transmitted in a fixed slot location, such as the symbols 0-3 as shown in FIG. 3A. The PSS and SSS may be used by UEs for cell search and acquisition. The PSS may provide half-frame timing, the SS may provide the CP length and frame timing. The PSS and SSS may provide the cell identity. The PBCH carries some basic system information, such as downlink system bandwidth, timing information within radio frame, SS burst set periodicity, system frame number, etc. The SS blocks may be organized into SS bursts to support beam sweeping. Further system information such as, remaining minimum system information (RMSI), system information blocks (SIGs), other system information (OSI) can be transmitted on a physical downlink shared channel (PDSCH) in certain subframes. The SS block can be transmitted up to sixty-four times, for example, with up to sixty-four different beam directions for mmW. The up to sixty-four transmissions of the SS block are referred to as the SS burst set. SS blocks in an SS burst set are transmitted in the same frequency region, while SS blocks in different SS bursts sets can be transmitted at different frequency locations.

As shown in FIG. 3B, the SS blocks may be organized into SS burst sets to support beam sweeping. As shown, each SSB within a burst set may be transmitted using a different beam, which may help a UE quickly acquire both transmit (Tx) and receive (Rx) beams (particular for mmW applications). A physical cell identity (PCI) may still decoded from the PSS and SSS of the SSB.

A control resource set (CORESET) for systems, such as an NR and LTE systems, may comprise one or more control resource (e.g., time and frequency resources) sets, configured for conveying PDCCH, within the system bandwidth. Within each CORESET, one or more search spaces (e.g., common search space (CSS), UE-specific search space (USS), etc.) may be defined for a given UE. According to aspects of the present disclosure, a CORESET is a set of time and frequency domain resources, defined in units of resource element groups (REGs). Each REG may comprise a fixed number (e.g., twelve) tones in one symbol period (e.g., a symbol period of a slot), where one tone in one symbol period is referred to as a resource element (RE). A fixed number of REGs may be included in a control channel element (CCE). Sets of CCEs may be used to transmit new radio PDCCHs (NR-PDCCHs), with different numbers of CCEs in the sets used to transmit NR-PDCCHs using differing aggregation levels. Multiple sets of CCEs may be defined as search spaces for UEs, and thus a NodeB or other base station may transmit an NR-PDCCH to a UE by transmitting the NR-PDCCH in a set of CCEs that is defined as a decoding candidate within a search space for the UE, and the UE may receive the NR-PDCCH by searching in search spaces for the UE and decoding the NR-PDCCH transmitted by the NodeB.

In NR, a wake up signal (WUS) is defined which is monitored by the UE outside the Active Time. The WUS may be detected with relatively simple receiver components, allowing the UE to stay in a reduced power state. The WUS indicates whether the UE should wake up (more fully) for PDCCH monitoring.

### Example Fast Transitions Between Legacy Radio Access Technologies (RATs) and Non-Legacy RATs Based on Energy Thresholds

Aspects of the present disclosure relate to wireless communications, and more particularly, to techniques for fast transitions between different radio access technologies (RATs) used for communications between a user equipment (UE) and a base station based on energy thresholds.

In many wireless communications networks, communications may be performed using a first radio access technology (RAT) and a second RAT. The first RAT may be one of a variety of legacy RATs and the second RAT may be one of a variety of non-legacy RATs. For example, in a network in which a non-legacy RAT, such as NR, is used for data communications, legacy RATs, such as LTE, UMTS, or the like, may be used for voice communications (e.g., packet-based voice communications, or Voice over Packet Switched (VoPS) such as Voice over LTE (VoLTE); or voice communications using circuit-switched fallback (CSFB) on a Universal Mobile Telecommunications Service (UMTS) network, a GSM network, or the like). When a voice communication session is initiated (e.g., by a user equipment (UE) camped on a cell supporting a non-legacy RAT, such as when a UE is camped on an NR cell in standalone mode), initiation of the voice communication session may trigger a fallback to communications using a legacy RAT. When the voice communication session is terminated, a redirection procedure may be performed, which allows the UE to camp back on a cell supporting a non-legacy RAT.

In some cases, network operators may provide information to a UE including information about frequencies (e.g., absolute radio frequency channel numbers, or AFRCNs) on which communications using a non-legacy RAT may be supported. The frequency information may include a priority for each frequency on which communications using the non-legacy RAT may be supported, and a UE may attempt to camp on cells associated with the highest priority frequencies after a voice communication session is terminated. However, in some scenarios, signals received from cells operating on the highest priority frequencies may be received at lower energies (and consequently, lower received signal strengths) than other available frequencies, which may delay the process of a UE camping back on a non-legacy RAT system after the voice communication session is terminated.

FIG. 4 illustrates example operations 400 that may be performed to support fast transitions between legacy RATs and non-legacy RATs based on energy thresholds, in accordance with some aspects of the present disclosure. Operations 400 may be performed, for example, by a UE, such as UE 120 illustrated in FIG. 1.

As illustrated, operations 400 may begin at block 402, where a UE terminates an active communications session on a first radio access technology (RAT). As discussed, the active communications session on the first RAT may be a voice communications session performed using Voice over Packet Switched (VoPS), such as Voice over LTE (VoLTE), or on circuit switched fallback (CSFB). In some aspects, the first RAT may be an LTE, UMTS, or other legacy RAT on which VoPS communications is not supported, and a second RAT on which the UE is to camp, as discussed in further detail below, may be a non-legacy RAT, such as NR, or other RAT on which VoPS communications is supported.

At block 404, the UE measures signal strength of one or more frequencies supporting a second RAT in a configured list of frequencies. The measured signal strength may be, for example, based on measurements performed on various downlink reference signals (RSs), such as channel state information (CSI) RSs (CSI-RSs), sounding RSs (SRSs), demodulation RSs (DMRSs), or the like. To measure the signal strength of one or more frequencies supporting the second RAT, the UE can tune to a frequency, detect one or more synchronization signals transmitted by a network entity operating on the frequency (e.g., the PSS and SSS in an SSB) to align the UE with the timing of the network entity, and measure one or more signals transmitted by the network entity (e.g., RSs) based on the timing of the network entity identified from the synchronization signals. In some aspects, the UE may be configured with timing information associated with each frequency in the configured list of frequencies and can use this timing information to measure various signals (e.g., RSs) transmitted by the network entity on each frequency in the configured list of frequencies.

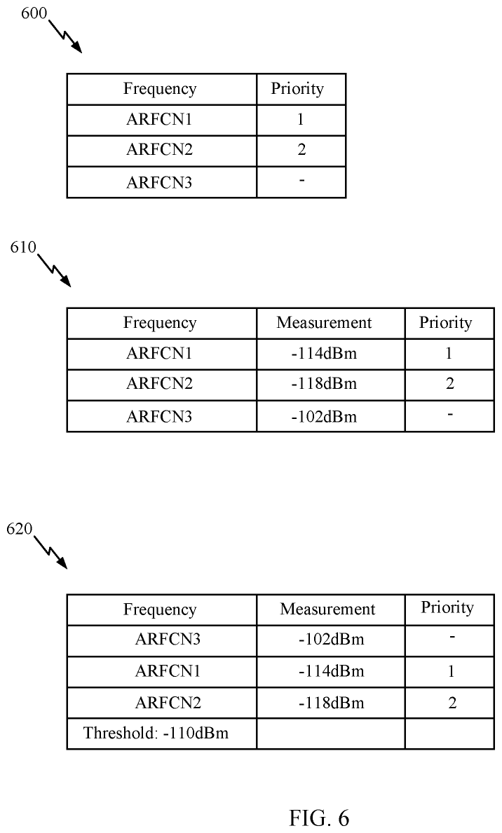

At block 406, the UE identifies a frequency to camp on based on a priority and a measured signal strength of one or more frequencies in the configured list of frequencies. In some aspects, the UE can attempt to camp on higher priority frequencies over lower priority frequencies for frequencies having measured signal strengths exceeding a threshold signal strength before attempting to camp on lower priority frequencies or fallback frequencies having measured signal strengths exceeding the threshold signal strength. Thus, in some aspects (as discussed in further detail below with respect to FIG. 6), fallback frequencies (e.g., frequencies having no assigned priority level) may ultimately be identified as a frequency to camp on when frequencies with higher priority levels do not have a sufficient signal strength for the UE to attempt to camp on. More generally, in identifying a frequency to camp on, the UE can disregard frequencies having measured signal strengths below a threshold signal strength regardless of the priority level assigned to these frequencies, as the UE may determine that it is unlikely to successfully camp on these frequencies.

At block 408, the UE camps on the identified frequency. After the UE camps on the identified frequency, the UE can perform data and/or voice communications with a network entity operating on the identified frequency. In some aspects, in camping on the identified frequency, the UE can camp on a network entity operating on the identified frequency and using a non-legacy RAT that supports packet-based data communications as well as VoPS communications.

In some aspects, the UE may receive a configuration message from a network entity (e.g., a serving cell) to configure the UE with a list of frequencies on which the UE can camp. The configuration message may include, for example, a redirection message received from a network entity after the UE terminates the active communications session on the first (e.g., legacy) RAT, or other messages that configure the UE to resume communications on a second (e.g., non-legacy) RAT after an active communications session on the first RAT is terminated. The configuration message may include the configured list of frequencies (e.g., ARFCNs) on which communications using a second RAT are supported, as well as priority information for each frequency in the configured list of frequencies. For example, and as discussed in further detail below with respect to FIG. 6, in a deployment where three frequencies, ARFCN1, ARFCN2, and ARFCN3, support communications using a second RAT, the network entity may include information indicating that ARFCN1 has a priority level of 1, ARFCN2 has a priority level of 2, and ARFCN3 has no assigned priority level. The assignment of no priority level may indicate that the corresponding ARFCN is a fallback ARFCN if no other ARFCNs are suitable for camping or is the lowest priority ARFCN in the configured list of frequencies.

To identify a frequency in the configured list of frequencies on which to camp, the UE may measure the signal strength of signals received on each frequency in the configured list of frequencies. For example, the UE may measure a received signal strength indicator (RSSI) for signals transmitted by cells on each frequency in the configured list of frequencies, or the like.

After measuring the signal strength of each of the frequencies in the configured list of frequencies, the UE can compare the measured signal strength for each frequency to a minimum energy threshold. The minimum energy threshold generally corresponds to a minimum received signal strength for which a threshold level of reliability may be assumed for communications between a UE and a serving cell. The minimum energy threshold may be defined a priori for the UE based on various properties of the UE (e.g., a number of receive chains, or other relevant properties of the UE)

The configured list of frequencies may be received from the network entity in order of priority. The UE may update the configured list of frequencies or take one or more other actions based on the measured signal strength of each frequency in the configured list of frequencies and a comparison of the measured signal strength to a threshold signal strength. Generally, frequencies for which the measured signal strength is below the minimum energy threshold may be moved to the bottom of the configured list of frequencies, while frequencies for which the measured signal strength is above the minimum energy threshold may be moved to the top of the configured list of frequencies. For example, if a frequency with a priority of 1 has a received signal strength that is below the minimum energy threshold, the UE my move this frequency to the bottom of the configured list of frequencies, or at least below the frequencies in the configured list of frequencies that have measured signal strengths that are above the minimum energy threshold, since the UE may not be able to successfully camp on cells on that frequency. Thus, the updated, re-sorted list of frequencies may be ordered such that frequencies having the highest measured signal strengths, or at least signal strengths that exceed the minimum energy threshold, are closer to the top of the updated list of frequencies than frequencies having measured signal strengths that are below the minimum energy threshold regardless of the priority originally assigned to each frequency.

After the UE updates and re-sorts the configured list of frequencies, the UE may attempt to camp on a cell associated with the highest-ranked frequency in the updated and re-sorted list of frequencies. If the UE is not able to successfully camp on a cell associated with the frequency at the top of the updated list of frequencies, the UE may attempt to camp on a cell associated with the second-highest-ranked frequency, then the third-highest-ranked-frequency, and so on until the UE is successfully able to camp on a cell in the network. By doing so, the UE may prioritize attempts to camp on cells associated with frequencies that are more likely to result in a successful attempt to camp (and in a quicker resumption of camping on a cell supporting a second (e.g., non-legacy) RAT) than cells associated with frequencies that are less likely to result in a successful attempt to camp.

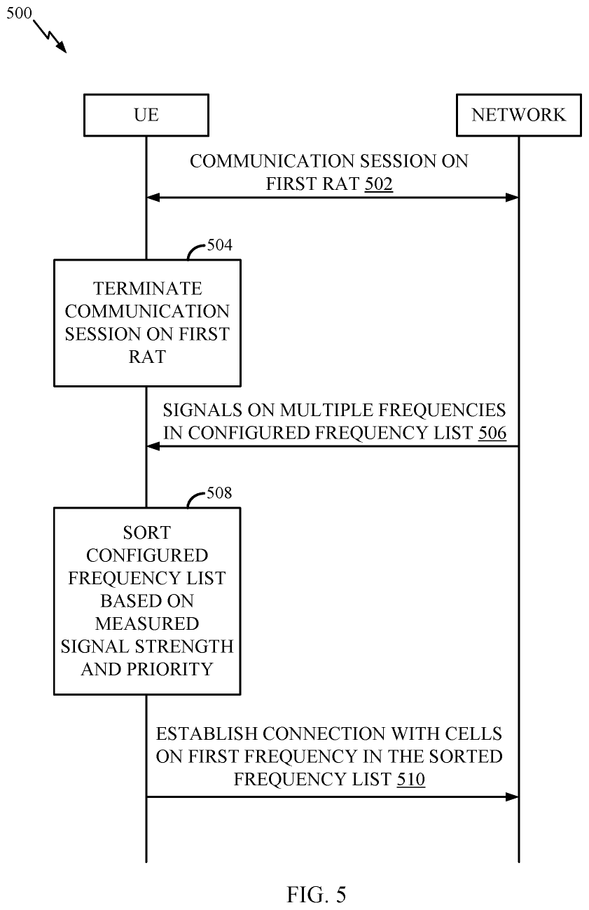

FIG. 5 illustrates an example timeline 500 of transitions between a first RAT and a second RAT, in accordance with some aspects of the present disclosure. As illustrated, timeline 500 begins with a UE communicating 502 with a network in a voice communication session between the UE and the network. As discussed, the voice communication session may be performed on a first RAT, and the first RAT may be a legacy RAT on which voice communications are performed using, for example, VoLTE or CSFB communications.

At block 504, the UE terminates the voice communication session with the UE. The voice communication session with the UE may be terminated manually (e.g., by the user hanging up or otherwise disconnecting from the voice communication session) or may be terminated due to a dropped call or connection failure between the UE and the network.

Subsequent to terminating the voice communication session at block 504, the UE receives signals 506 on multiple frequencies in the configured frequency list. The signals may be, for example, reference signals, such as cell-specific reference signals, synchronization signals, or other signaling received at known times from cells operating on each frequency in the configured frequency list.

At block 508, the UE sorts the configured frequency list based on the measured signal strength of each signal 506 received on the frequencies in the configured frequency list and the priority associated with each frequency. The measured signal strength may be measured, for example, in decibel-milliwatts or other metrics indicative of a strength of each signal 506 received on the frequencies in the configured frequency list. Based on the measured signal strength, the configured frequency list may be updated and re-ordered such that the frequencies having received signal strengths that exceed a minimum energy threshold are at the top of the updated frequency list (i.e., are more likely to be selected for the UE to camp on) than frequencies having received signal strengths that do not exceed the minimum energy threshold.

Based on the updated frequency list, the UE transmits one or more messages to establish 510 a connection with cells on a first frequency in the sorted frequency list. In some embodiments, the first frequency may be a frequency having the highest priority and an acceptable signal strength (e.g., a signal strength that exceeds the minimum energy threshold). In another embodiment, the first frequency may be the frequency having the highest received signal strength (that may, but need not, exceed the minimum energy threshold) regardless of the priority of the frequency assigned to it by the network.

FIG. 6 illustrates example prioritizations of frequencies for communications using a second (e.g., non-legacy) RAT after discontinuing communications using a first (e.g., legacy) RAT, in accordance with some aspects of the present disclosure. Table 600 illustrates a configured frequency list that may be received from a network entity indicating the frequencies on which communications using a second RAT may be supported and priority levels for each frequency in the list. As illustrated, three frequencies, ARFCN1, ARFCN2, and ARFCN3, may be available for the UE to camp on. Using priority-based camping techniques, a UE may attempt to camp on cells on ARFCN1 first, and if that fails, attempt to camp on cells on ARFCN2, and then attempt to camp on cells on ARFCN3. To accelerate the process of camping on a cell operating on a frequency that supports communications on a second RAT, aspects described herein may update and re-order the frequencies in the configured frequency list based on the signal strength of signals received on each frequency.

Table 610 illustrates example signal strength measurements for each ARFCN in the configured frequency list. As illustrated, in this example, the UE receives signals from cells operating on the ARFCN1 band at a strength of −114 dBm; signals from cells operating on the ARFCN2 band at a strength of −118 dBm; and signals from cells operating on the ARFCN3 band at −102 dBm. As discussed, using priority-based camping, the UE may attempt to camp on cells on ARFCN1 first, and if that fails, attempt to camp on cells on ARFCN2, and then attempt to camp on cells on ARFCN3, even though ARFCN3 has the strongest received signal strength of the ARFCNs included in the configured frequency list.

Table 620 illustrates an example of an updated list of frequencies based on the measured signal strength of signals received on each of the frequencies. As illustrated, given a minimum energy threshold of −110 dBm, where larger numbers (i.e., numbers closer to 0 in a counting scheme where 0 represents the largest possible value) represent acceptable levels of energy and smaller numbers (i.e., numbers further away from 0 in a counting scheme were 0 represents the largest possible value) represent energy levels on which success of UE camping on the frequency is expected to be low, only ARFCN3 may pass the minimum energy threshold. Thus, as illustrated, ARFCN3 may be the first entry in the updated list of frequencies, and the other frequencies may be positioned in lower spots on the list, even though ARFCN3 has a lower priority assigned to it than ARFCN1 and ARFCN2.

Based on the updated list of frequencies illustrated in table 620, the UE may attempt to acquire a connection with a cell operating on ARFCN3. If the UE is unable to acquire a connection with a cell operating on ARFCN3, the UE may proceed with attempting to acquire a connection with a cell operating on ARFCN1 and need not perform further signal quality measurements, as the updated list of cells may be sorted based on measured signal strength already.

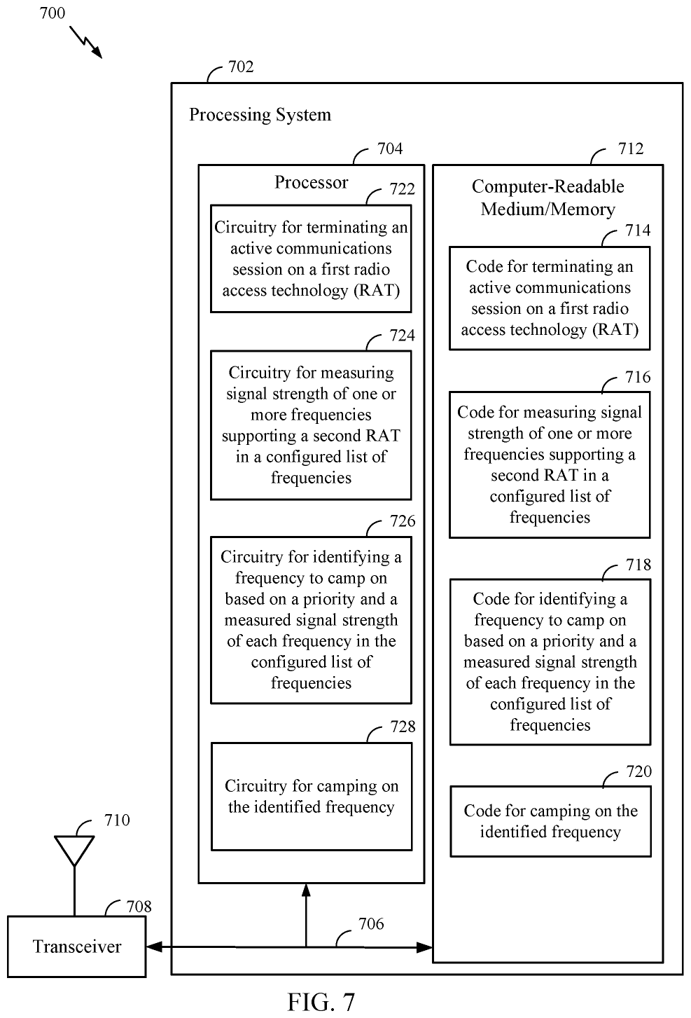

FIG. 7 illustrates a communications device 700 that may include various components (e.g., corresponding to means-plus-function components) configured to perform operations for the techniques disclosed herein, such as the operations illustrated in FIG. 4. The communications device 700 includes a processing system 702 coupled to a transceiver 708. The transceiver 708 is configured to transmit and receive signals for the communications device 700 via an antenna 710, such as the various signals as described herein. The processing system 702 may be configured to perform processing functions for the communications device 700, including processing signals received and/or to be transmitted by the communications device 700.

The processing system 702 includes a processor 704 coupled to a computer-readable medium/memory 712 via a bus 706. In certain aspects, the computer-readable medium/memory 712 is configured to store instructions (e.g., computer-executable code) that when executed by the processor 704, cause the processor 704 to perform the operations illustrated in FIG. 4, or other operations for performing the various techniques discussed herein. In certain aspects, computer-readable medium/memory 712 stores code 714 for terminating an active communications session on a first radio access technology (RAT); code 716 for measuring signal strength of one or more frequencies supporting a second RAT in a configured list of frequencies; code 718 for identifying a frequency to camp on based on a priority and a measured signal strength of each frequency in the configured list of frequencies; and code 720 for camping on the identified frequency. In certain aspects, the processor 704 has circuitry configured to implement the code stored in the computer-readable medium/memory 712. The processor 704 includes circuitry 722 for terminating an active communications session on a first radio access technology (RAT); circuitry 724 for measuring signal strength of one or more frequencies supporting a second RAT in a configured list of frequencies; circuitry 726 for identifying a frequency to camp on based on a priority and a measured signal strength of each frequency in the configured list of frequencies; and circuitry 728 for camping on the identified frequency.

### Example Clauses

Clause 1: A method for wireless communications by a user equipment (UE), comprising: terminating an active communications session on a first radio access technology (RAT); measuring signal strength of one or more frequencies supporting a second RAT in a configured list of frequencies; identifying a frequency to camp on based on a priority and a measured signal strength of one or more frequencies in the configured list of frequencies; and camping on the identified frequency.

Clause 2: The method of Clause 1, further comprising: receiving, from a network entity, a configuration message including the configured list of frequencies, wherein the configured list of frequencies includes priority information for each frequency in the configured list of frequencies.

Clause 3: The method of Clause 2, wherein the configuration message comprises a redirection message received from a network entity after terminating the active communication session on the first RAT.

Clause 4: The method of any one of Clauses 1 through 3, wherein identifying the frequency of the one or more frequencies comprises: measuring a signal strength of a signal received on a first frequency in the configured list of frequencies, wherein the first frequency has a highest priority level in the configured list of frequencies and the configured list of frequencies comprises frequencies sorted by priority level; comparing the measured signal strength of the signal received on the first frequency to a threshold signal strength; and taking one or more actions based on the comparison.

Clause 5: The method of Clause 4, wherein the one or more actions comprises selecting the first frequency if the measured signal strength exceeds the threshold signal strength.

Clause 6: The method of Clause 4, wherein the one or more actions comprises: determining that the measured signal strength of the signal received on the first frequency is less than the threshold signal strength; updating the configured list of frequencies by moving the first frequency to a bottom of the configured list of frequencies; and selecting a second frequency for measurement, wherein the second frequency has a next highest priority level of the frequencies in the updated list of frequencies.

Clause 7: The method of any one of Clauses 1 through 6, wherein identifying the frequency to camp on comprises: measuring a signal strength of a received signal on each frequency in the configured list of frequencies; and re-ordering the configured list of frequencies based on the measured signal strength of the received signal on each frequency in the configured list of frequencies and a priority associated with each frequency such that a first frequency in the re-ordered configured list of frequencies corresponds to a frequency having a highest priority of frequencies in the configured list of frequencies that satisfy a threshold signal strength.

Clause 8: The method of Clause 7, further comprising: based on the re-ordered configured list, scanning on the first frequency to camp on for communications using the second RAT.

Clause 9: The method of any one of Clauses 1 through 9, wherein the active communication session on the first RAT comprises one or both of a Voice over Packet Switched (VoPS) call or a circuit switched fallback (CSFB) call.

Clause 10: A system, comprising: a memory having executable instructions stored thereon; and a processor configured to execute the executable instructions to perform the operations of any one of Clauses 1 through 9.

Clause 11: A system, comprising: means for performing the operations of any one of Clauses 1 through 9.

Clause 12: A computer-readable medium having instructions stored thereon which, when executed by a processor, performs the operations of any one of Clauses 1 through 9.

### Additional Considerations

The techniques described herein may be used for various wireless communication technologies, such as NR (for example, 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

The techniques described herein may be used for the wireless networks and radio technologies mentioned above as well as other wireless networks and radio technologies. For clarity, while aspects may be described herein using terminology commonly associated with 3G, 4G, or 5G wireless technologies, aspects of the present disclosure can be applied in other generation-based communication systems.

In 3GPP, the term “cell” can refer to a coverage area of a Node B (NB) or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. A BS may provide communication coverage for a macro cell, a pico cell, a femto cell, or other types of cells. A macro cell may cover a relatively large geographic area (for example, several kilometers in radius) and may allow unrestricted access by UEs with service subscription. A pico cell may cover a relatively small geographic area and may allow unrestricted access by UEs with service subscription. A femto cell may cover a relatively small geographic area (for example, a home) and may allow restricted access by UEs having an association with the femto cell (for example, UEs in a Closed Subscriber Group (CSG), UEs for users in the home, etc.). A BS for a macro cell may be referred to as a macro BS. A BS for a pico cell may be referred to as a pico BS. ABS for a femto cell may be referred to as a femto BS or a home BS.

A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (for example, a smart ring, a smart bracelet, etc.), an entertainment device (for example, a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (for example, remote device), or some other entity. A wireless node may provide, for example, connectivity for or to a network (for example, a wide area network such as Internet or a cellular network) via a wired or wireless communication link. Some UEs may be considered Internet-of-Things (IoT) devices, which may be narrowband IoT (NB-IoT) devices.

Some wireless networks (for example, LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block” (RB)) may be 12 subcarriers (or 180 kHz). Consequently, the nominal Fast Fourier Transfer (FFT) size may be equal to 128, 256, 512, 1024 or 2048 for system bandwidth of 1.25, 2.5, 5, 10, or 20 megahertz (MHz), respectively. The system bandwidth may also be partitioned into subbands. For example, a subband may cover 1.08 MHz (for example, 6 RBs), and there may be 1, 2, 4, 8, or 16 subbands for system bandwidth of 1.25, 2.5, 5, 10 or 20 MHz, respectively. In LTE, the basic transmission time interval (TTI) or packet duration is the 1 ms subframe.

NR may utilize OFDM with a CP on the uplink and downlink and include support for half-duplex operation using TDD. In NR, a subframe is still 1 ms, but the basic TTI is referred to as a slot. A subframe contains a variable number of slots (for example, 1, 2, 4, 8, 16, . . . slots) depending on the subcarrier spacing. The NR RB is 12 consecutive frequency subcarriers. NR may support a base subcarrier spacing of 15 KHz and other subcarrier spacing may be defined with respect to the base subcarrier spacing, for example, 30 kHz, 60 kHz, 120 kHz, 240 kHz, etc. The symbol and slot lengths scale with the subcarrier spacing. The CP length also depends on the subcarrier spacing. Beamforming may be supported and beam direction may be dynamically configured. MIMO transmissions with precoding may also be supported. In some examples, MIMO configurations in the DL may support up to 8 transmit antennas with multi-layer DL transmissions up to 8 streams and up to 2 streams per UE. In some examples, multi-layer transmissions with up to 2 streams per UE may be supported. Aggregation of multiple cells may be supported with up to 8 serving cells.

In some examples, access to the air interface may be scheduled. A scheduling entity (for example, a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (for example, one or more other UEs), and the other UEs may utilize the resources scheduled by the UE for wireless communication. In some examples, a UE may function as a scheduling entity in a peer-to-peer (P2P) network, or in a mesh network. In a mesh network example, UEs may communicate directly with one another in addition to communicating with a scheduling entity.

As used herein, the term “determining” may encompass one or more of a wide variety of actions. For example, “determining” may include calculating, computing, processing, deriving, investigating, looking up (for example, looking up in a table, a database or another data structure), assuming and the like. Also, “determining” may include receiving (for example, receiving information), accessing (for example, accessing data in a memory) and the like. Also, “determining” may include resolving, selecting, choosing, establishing and the like.

As used herein, “or” is used intended to be interpreted in the inclusive sense, unless otherwise explicitly indicated. For example, “a or b” may include a only, b only, or a combination of a and b. As used herein, a phrase referring to “at least one of” or “one or more of” a list of items refers to any combination of those items, including single members. For example, “at least one of: a, b, or c” is intended to cover the possibilities of: a only, b only, c only, a combination of a and b, a combination of a and c, a combination of b and c, and a combination of a and b and c.

The various illustrative components, logic, logical blocks, modules, circuits, operations and algorithm processes described in connection with the implementations disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the implementations described in this disclosure may be readily apparent to persons having ordinary skill in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

1. A method for wireless communications by a user equipment (UE), comprising:
terminating an active communications session on a first radio access technology (RAT);
measuring signal strength of one or more frequencies supporting a second RAT in a configured list of frequencies;
identifying a frequency to camp on based on a priority and a measured signal strength of one or more frequencies in the configured list of frequencies; and
camping on the identified frequency.

2. The method of claim 1, further comprising:
receiving, from a network entity, a configuration message including the configured list of frequencies, wherein the configured list of frequencies includes priority information for each frequency in the configured list of frequencies.

3. The method of claim 2, wherein the configuration message comprises a redirection message received from a network entity after terminating the active communication session on the first RAT.

4. The method of claim 1, wherein identifying the frequency of the one or more frequencies comprises:
measuring a signal strength of a signal received on a first frequency in the configured list of frequencies, wherein the first frequency has a highest priority level in the configured list of frequencies and the configured list of frequencies comprises frequencies sorted by priority level;
comparing the measured signal strength of the signal received on the first frequency to a threshold signal strength; and
taking one or more actions based on the comparison.

5. The method of claim 4, wherein the one or more actions comprises selecting the first frequency if the measured signal strength exceeds the threshold signal strength.

6. The method of claim 4, wherein the one or more actions comprises:
determining that the measured signal strength of the signal received on the first frequency is less than the threshold signal strength;
updating the configured list of frequencies by moving the first frequency to a bottom of the configured list of frequencies; and
selecting a second frequency for measurement, wherein the second frequency has a next highest priority level of the frequencies in the updated list of frequencies.

7. The method of claim 1, wherein identifying the frequency to camp on comprises:
measuring a signal strength of a received signal on each frequency in the configured list of frequencies; and
re-ordering the configured list of frequencies based on the measured signal strength of the received signal on each frequency in the configured list of frequencies and a priority associated with each frequency such that a first frequency in the re-ordered configured list of frequencies corresponds to a frequency having a highest priority of frequencies in the configured list of frequencies that satisfy a threshold signal strength.

8. The method of claim 7, further comprising:
based on the re-ordered configured list, scanning on the first frequency to camp on for communications using the second RAT.

9. The method of claim 1, wherein the active communication session on the first RAT comprises one or both of a Voice over Packet Switched (VoPS) call or a circuit switched fallback (CSFB) call.

10. An apparatus for wireless communications by a user equipment (UE), comprising:
a processor configured to:
terminate an active communications session on a first radio access technology (RAT);
measure signal strength of one or more frequencies supporting a second RAT in a configured list of frequencies;
identify a frequency to camp on based on a priority and a measured signal strength of one or more frequencies in the configured list of frequencies; and
camp on the identified frequency; and
a memory.

11. The apparatus of claim 10, wherein the processor is further configured to:
receive, from a network entity, a configuration message including the configured list of frequencies, wherein the configured list of frequencies includes priority information for each frequency in the configured list of frequencies.

12. The apparatus of claim 11, wherein the configuration message comprises a redirection message received from a network entity after terminating the active communication session on the first RAT.

13. The apparatus of claim 10, wherein the processor is configured to identify the frequency of the one or more frequencies by:
measuring a signal strength of a signal received on a first frequency in the configured list of frequencies, wherein the first frequency has a highest priority level in the configured list of frequencies and the configured list of frequencies comprises frequencies sorted by priority level;
comparing the measured signal strength of the signal received on the first frequency to a threshold signal strength; and
taking one or more actions based on the comparison.

14. The apparatus of claim 13, wherein the one or more actions comprises selecting the first frequency if the measured signal strength exceeds the threshold signal strength.

15. The apparatus of claim 13, wherein the one or more actions comprises:
determining that the measured signal strength of the signal received on the first frequency is less than the threshold signal strength;
updating the configured list of frequencies by moving the first frequency to a bottom of the configured list of frequencies; and
selecting a second frequency for measurement, wherein the second frequency has a next highest priority level of the frequencies in the updated list of frequencies.

16. The apparatus of claim 10, wherein the processor is configured to identify the frequency to camp on by:
measuring a signal strength of a received signal on each frequency in the configured list of frequencies; and
re-ordering the configured list of frequencies based on the measured signal strength of the received signal on each frequency in the configured list of frequencies and a priority associated with each frequency such that a first frequency in the re-ordered configured list of frequencies corresponds to a frequency having a highest priority of frequencies in the configured list of frequencies that satisfy a threshold signal strength.

17. The apparatus of claim 16, wherein identifying the frequency to camp on comprises:
based on the re-ordered configured list, scanning on the first frequency to camp on for communications using the second RAT.

18. The apparatus of claim 10, wherein the active communication session on the first RAT comprises one or both of a Voice over Packet Switched (VoPS) call or a circuit switched fallback (CSFB) call.

19. An apparatus for wireless communications by a user equipment (UE), comprising:
means for terminating an active communications session on a first radio access technology (RAT);
means for measuring signal strength of one or more frequencies supporting a second RAT in a configured list of frequencies;
means for identifying a frequency to camp on based on a priority and a measured signal strength of one or more frequencies in the configured list of frequencies; and
means for camping on the identified frequency.

20. The apparatus of claim 19, further comprising:
means for receiving, from a network entity, a configuration message including the configured list of frequencies, wherein the configured list of frequencies includes priority information for each frequency in the configured list of frequencies.

21. The apparatus of claim 20, wherein the configuration message comprises a redirection message received from a network entity after terminating the active communication session on the first RAT.

22. The apparatus of claim 19, wherein the means for identifying the frequency of the one or more frequencies comprises:
means for measuring a signal strength of a signal received on a first frequency in the configured list of frequencies, wherein the first frequency has a highest priority level in the configured list of frequencies and the configured list of frequencies comprises frequencies sorted by priority level;
means for comparing the measured signal strength of the signal received on the first frequency to a threshold signal strength; and
means for taking one or more actions based on the comparison.

23. The apparatus of claim 22, wherein the one or more actions comprises selecting the first frequency if the measured signal strength exceeds the threshold signal strength.

24. The apparatus of claim 22, wherein the one or more actions comprises:
determining that the measured signal strength of the signal received on the first frequency is less than the threshold signal strength;
updating the configured list of frequencies by moving the first frequency to a bottom of the configured list of frequencies; and
selecting a second frequency for measurement, wherein the second frequency has a next highest priority level of the frequencies in the updated list of frequencies.

25. The apparatus of claim 19, wherein the means for identifying the frequency to camp on comprises:
means for measuring a signal strength of a received signal on each frequency in the configured list of frequencies; and
means for re-ordering the configured list of frequencies based on the measured signal strength of the received signal on each frequency in the configured list of frequencies and a priority associated with each frequency such that a first frequency in the re-ordered configured list of frequencies corresponds to a frequency having a highest priority of frequencies in the configured list of frequencies that satisfy a threshold signal strength.

26. The apparatus of claim 25, further comprising:
means for scanning, based on the re-ordered configured list, on the first frequency to camp on for communications using the second RAT.

27. The apparatus of claim 19, wherein the active communication session on the first RAT comprises one or both of a Voice over Packet Switched (VoPS) call or a circuit switched fallback (CSFB) call.

28. A computer-readable medium having executable instructions stored thereon which, when executed by a processor, performs an operation for wireless communications by a user equipment (UE), the operation comprising:
terminating an active communications session on a first radio access technology (RAT);
measuring signal strength of one or more frequencies supporting a second RAT in a configured list of frequencies;
identifying a frequency to camp on based on a priority and a measured signal strength of one or more frequencies in the configured list of frequencies; and
camping on the identified frequency.

29. The computer-readable medium of claim 28, wherein the operation further comprises:
receiving, from a network entity, a configuration message including the configured list of frequencies, wherein the configured list of frequencies includes priority information for each frequency in the configured list of frequencies.

30. The computer-readable medium of claim 28, wherein identifying the frequency of the one or more frequencies comprises:
measuring a signal strength of a signal received on a first frequency in the configured list of frequencies, wherein the first frequency has a highest priority level in the configured list of frequencies and the configured list of frequencies comprises frequencies sorted by priority level;
comparing the measured signal strength of the signal received on the first frequency to a threshold signal strength; and
taking one or more actions based on the comparison.
